(19) United States
(12) Patent Application Publication
(10) Pub. No.: US 2005/0154752 A1
(43) Pub. Date: Jul. 14, 2005

(54) Display apparatus and method that display navigatable objects

(75) Inventor: Hye-kyung Ko, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/030,893

(22) Filed: Jan. 10, 2005

(30) Foreign Application Priority Data
Jan. 8, 2004 (KR) 10-2004-0001199

(51) Int. Cl. G06F 7/00

(52) U.S. Cl. 707/102

(57) ABSTRACT

A display apparatus and method that display directions in which objects navigatable from a currently activated object are located. The display apparatus includes a display unit, which displays an application program, an application program executing unit, which executes the application program so that the application program is displayed on a screen of the display unit, and a controlling unit, which determines whether there are objects navigatable from a currently activated object on the screen of the display unit and displays direction information on directions in which the objects navigatable from the currently activated object are located. Accordingly, directions in which the objects navigatable from the currently activated object are located are automatically displayed, thereby enabling a user to view the directions in which the objects navigatable from the currently activated object are located in advance.

### CROSS-REFERENCE TO RELATED APPLICATION

This application claims priority from Korean Patent Application No. 10-2004-0001199 filed on Jan. 8, 2004 in the Korean Intellectual Property Office, the disclosure of which is incorporated herein by reference in its entirety.

### BACKGROUND OF THE INVENTION

1. Field of the Invention

The present invention relates to a display apparatus and method that display objects navigatable from a currently activated object, and more particularly, to a display apparatus and method that automatically display directions in which objects navigatable from a currently activated object are located.

2. Description of the Related Art

FIGS. 1A through 1C illustrate objects 10 each having highlight display capability in a conventional digital TV. Referring to FIG. 1A, each of the objects 10 is provided on a screen of the conventional digital TV, and the highlight display capability can be transferred from one object to other objects adjacent to the one object by using direction keys, i.e., ‘up’, ‘down’, ‘right’, and ‘left’ keys.

Referring to FIGS. 1B and 1C, if a user presses one of the direction keys after a particular object is activated (highlighted), a new object located in a predetermined direction indicated by the direction key pressed by the user is activated. An application program for conventional digital TVs supports an application program interface (API) that enables the cursor to move between the objects 10 with the help of the direction keys. An application programmer can register a particular object and objects that are navigatable from the particular object in up, down, right and left directions with the API.

FIG. 2 illustrates the relationship between an object with highlight display capability displayed on a screen of a conventional digital TV and objects navigatable therefrom. Information on object 2, object 3, ‘none’ and object 4, to which a cursor can be moved from an object 1 by one hit of any of the direction keys (‘up’, ‘down’, ‘right’, and ‘left’) of a remote controller, is registered with object 1. Likewise, information on ‘none’, object 1, and objects 5 and 4, to which the cursor can be moved from object 2 by one hit of any of the direction keys, is registered with object 2.

If a user presses the ‘up’ key of the remote controller with the object 1 highlighted, an application system obtains information on object 2 from the information registered with object 1 and moves the cursor from object 1 to object 2. Therefore, object 2 is activated, while object 1 is deactivated.

If the user presses the ‘up’ key once again when object 2 is highlighted, the cursor is moved from object 2 to nowhere because no navigatable object is found in that direction.

If the user presses the ‘down’ key of the remote controller when object 2 is highlighted, the application system obtains information on object 1 from the information registered with object 2 and moves the cursor from object 2 to object 1. Therefore, object 1 is activated, that is, highlighted, once again, while object 2 is deactivated.

However, since objects displayed on the screen of the conventional digital TV are navigatable from one another by using the direction keys of the remote controller, the more complicated the application system, the harder it is to instantly recognize objects to which the cursor can be navigated from a currently highlighted object. Therefore, it takes the user a while to get accustomed to using menus of the application system.

In other words, the user is less likely to have trouble with some application programs after learning how to use them. However, it may be very difficult for the user to handle downloadable application programs for a digital TV. Such application programs, which are transmitted with a broadcasting program by a broadcasting system, may be different from broadcasting program to broadcasting program.

Korean Patent Laid-open Publication No. 2002-0024457, entitled “Method of Selecting Icons of Modular Television and Remote Controller Therefor”, discloses a method in which a cursor is jumped from one iconic activated area to an adjacent iconic activated area on a screen in response to a direct key signal input using a remote controller with ‘up’, ‘down’, ‘right’, and ‘left’ direct keys. The disclosed method, however, may be inconvenient because it can only make the cursor jump one icon whenever a user presses any of the direction keys. Thus, the user must inconveniently press direction keys disposed at the remote controller several times to activate any desired icons.

### SUMMARY OF THE INVENTION

The present invention provides a display apparatus and method that automatically display directions in which objects navigatable from a currently activated object are located, thereby enabling a user to previously view directions in which the navigatable objects are located and easily manipulate the directions.

In accordance with an aspect of the present invention, there is provided a display apparatus that displays directions in which objects navigatable from a currently activated object are located, the display apparatus comprising a display unit, which displays an application program, an application program executing unit, which executes the application program so that the application program is displayed on a screen of the display unit, and a controlling unit, which determines whether there are objects navigatable from a currently activated object on the screen of the display unit and displays direction information on directions in which the objects navigatable from the currently activated object are located.

Alternatively, the controlling unit may display the direction information by highlighting the currently activated object.

In accordance with another aspect of the present invention, there is provided a display method that displays directions in which objects navigatable from a currently activated object are located, the display method comprising displaying an application program, and determining whether there are objects navigatable from a currently activated object on the screen of the display unit and displaying direction information on directions in which the objects navigatable from the currently activated object are located.

In addition, the determining operation may comprise searching for objects adjacent to the currently activated object by referring to a mapping table of the objects, obtaining information on relative locations of the searched objects, and determining whether the objects adjacent to the currently activated object are navigatable from the currently activated object, based on the information on locations of the objects adjacent to the currently activated object.

In another embodiment of the present invention, the display method may further comprise setting locations of direction indicators indicating direction information according to information on relative locations of the searched objects.

Further, in the displaying, the direction information may be displayed by highlighting the objects navigatable from the currently activated object. Here, the direction information may be displayed by representing the direction indicators on the currently activated object or the objects navigatable from the currently activated object, or by highlighting the objects navigatable from the currently activated object.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1C illustrate objects displayed on a screen of a conventional digital TV;

FIG. 2 is a diagram illustrating the relationship between a highlighted object displayed on the screen of the conventional digital TV and objects navigatable therefrom;

FIG. 3 is a block diagram of a display apparatus that displays directions in which objects navigatable from a currently activated object are located, according to the present invention;

FIG. 4 is a flowchart of a display method that displays directions in which objects navigatable from a currently activated object are located, according to the present invention; and

FIGS. 5A, 5B, 6A, and 6B are diagrams illustrating directions, in which objects navigatable from a currently activated object are located and displayed on a screen of the display apparatus, according to preferred embodiments of the present invention.

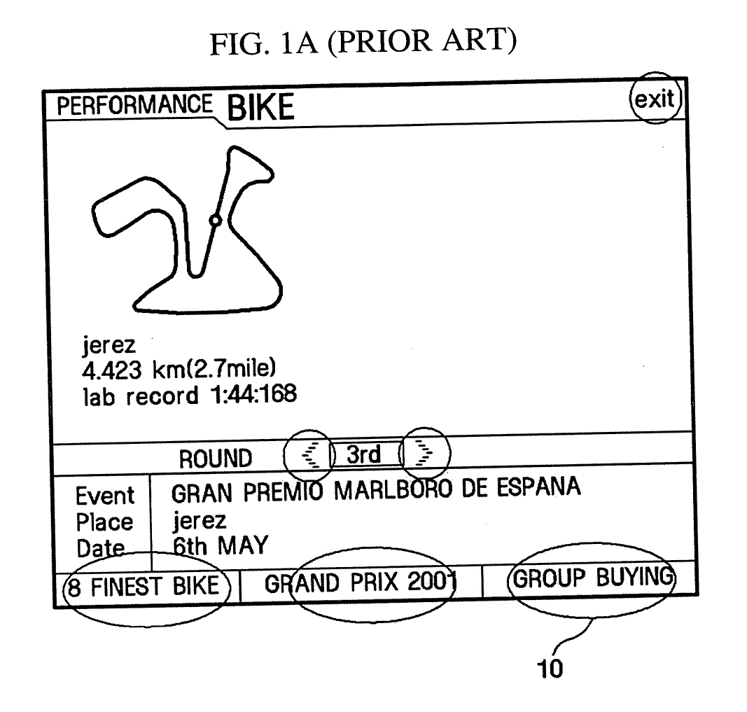

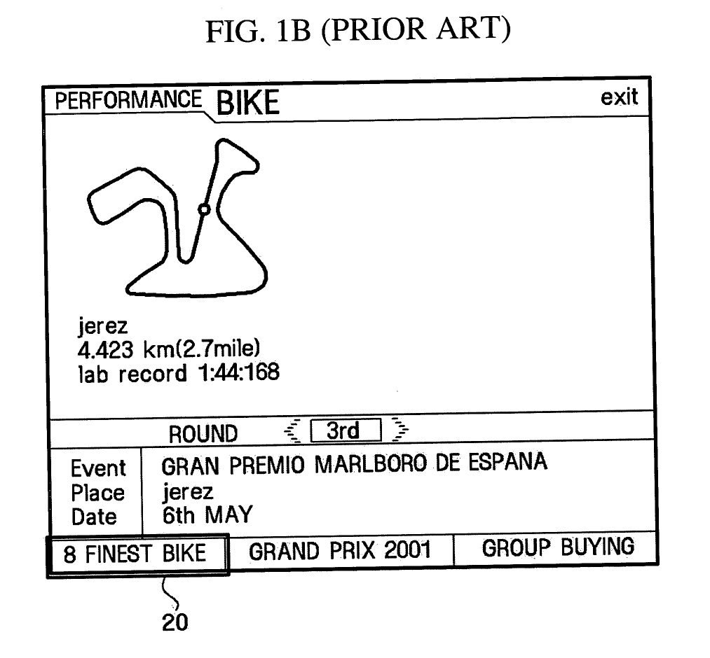

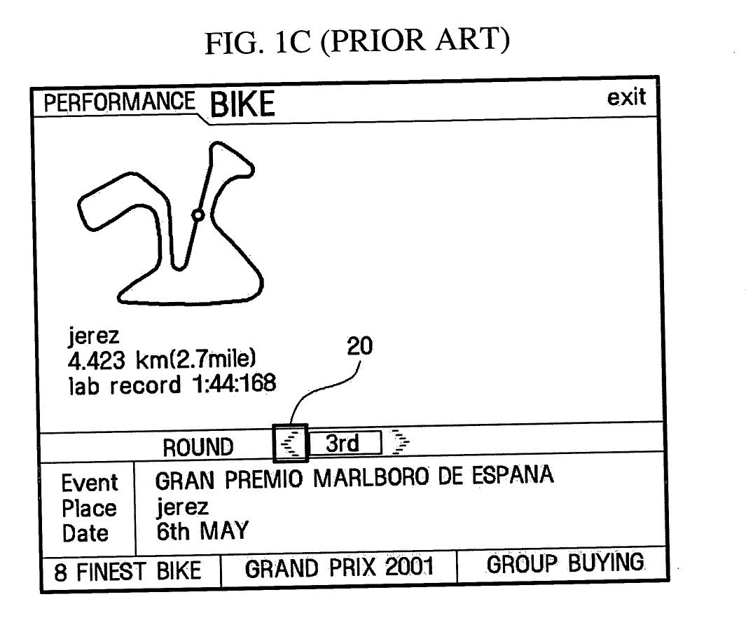

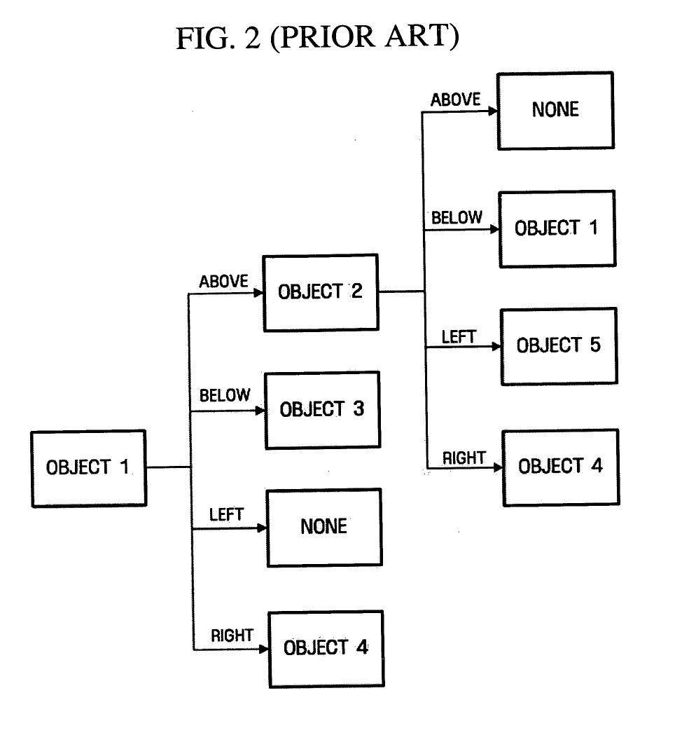

### DETAILED DESCRIPTION OF EXEMPLARY EMBODIMENTS OF THE INVENTION

Exemplary embodiments of the present invention will now be described with reference to the accompanying drawings.

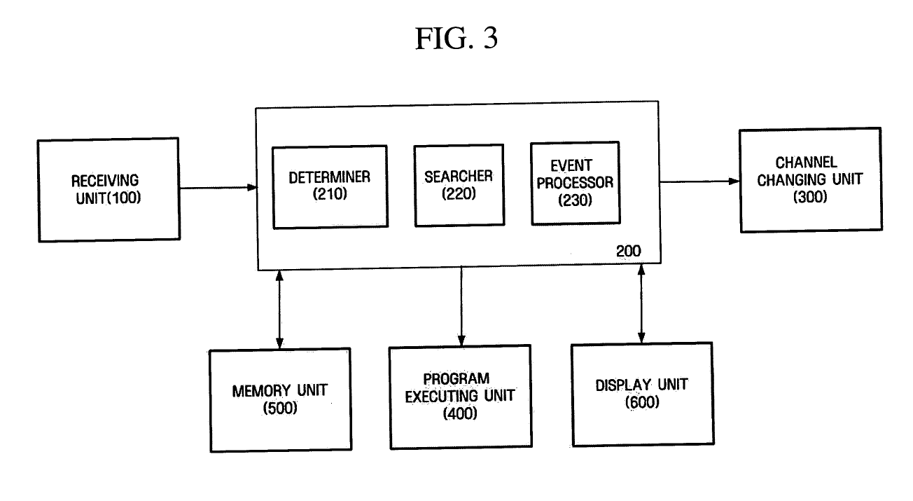

FIG. 3 is a block diagram illustrating a display apparatus that displays directions in which objects navigatable from a currently activated object are located, according to the present invention. Referring to FIG. 3, the display apparatus includes a receiving unit 100, a controlling unit 200, a channel changing unit 300, a program executing unit 400, a memory unit 500, and a display unit 600.

The receiving unit 100 receives a key signal input by a user, i.e., a command signal generated by the user manipulating a remote controller or a mouse.

The controlling unit 200 reads an application program stored in the memory unit 500, executes the application program so that the application program can be displayed on a screen, detects whether there are objects navigatable from the currently activated object, and displays information on directions in which the objects navigatable from the currently activated object are located using the display unit 600. In other words, the controlling unit 200 detects whether a predetermined object is currently activated in response to a key signal input by the user, searches for information on locations of objects navigatable from the predetermined object, and determines whether the cursor can be moved from the predetermined object to any of the objects navigatable from the predetermined object. The controlling unit 200 includes a determiner 210, a searcher 220, and an event processor 230.

The determiner 210 determines which operation the user desires to be executed based on the key signal input to the receiving unit 100. In other words, the determiner 210 determines whether the input key signal indicates a request for changing channels or a request for performing a function regarding the predetermined object and transmits the input key signal to the channel changing unit 300 or the searcher 220 depending on a result of the determination so that the request indicated by the input key signal can be met.

The searcher 220 detects whether the predetermined object is currently activated in response to the key signal input thereto and searches for information on locations of objects adjacent to the predetermined object. In other words, when there is a request for performing a function regarding the predetermined object, the searcher 220 detects whether the predetermined object is currently activated, and searches for information on locations of adjacent objects navigatable from the predetermined object to determine navigability. Here, the searcher 220 searches for information on the predetermined object and information on locations of the objects navigatable from the predetermined object and determines positions at which direction indicators, indicating directions in which the objects navigatable from the predetermined object are located, are to be displayed on the screen based on the searched location information on the navigatable objects.

The event processor 230 creates an event for the predetermined object, which is currently activated, and the objects navigatable from the predetermined object. Here, the event represents highlighting directions, in which the objects navigatable from the object are located, and direction indicators. The event can be represented by using various colors or shapes.

The channel changing unit 300 changes channels in response to the input key signal if the input key signal indicates a request for changing channels.

The program executing unit 400 executes an application program so that the application program can be displayed on the screen. That is, if the controlling unit 200 determines that there are objects navigatable from the predetermined object, the program executing unit 400 executes the application program to be displayed on the screen.

The memory unit 500 stores information on predetermined objects and directions in which objects navigatable from each of the predetermined objects are located. More specifically, the memory unit 500 stores operation information of each object displayed on, for example, a screen of a digital TV, and information on the relationship among each object and objects navigatable therefrom in a mapping table. For example, supposing that there are three objects A, B, and C, the memory unit 500 stores operating information and location information of each of the objects A, B, and C and location information of objects navigatable from each of the objects A, B and C in the mapping table.

The display unit 600 displays the application program executed by the program executing unit 400 and direction information on the screen together with a plurality of objects, the cursor, and the direction indicators.

A display method that displays directions, in which objects navigatable from a currently activated object are located, according to a preferred embodiment of the present invention can be applied to a downloadable user interface (UI) application program, for example, a home audio video interoperability (HAVI) UI application program.

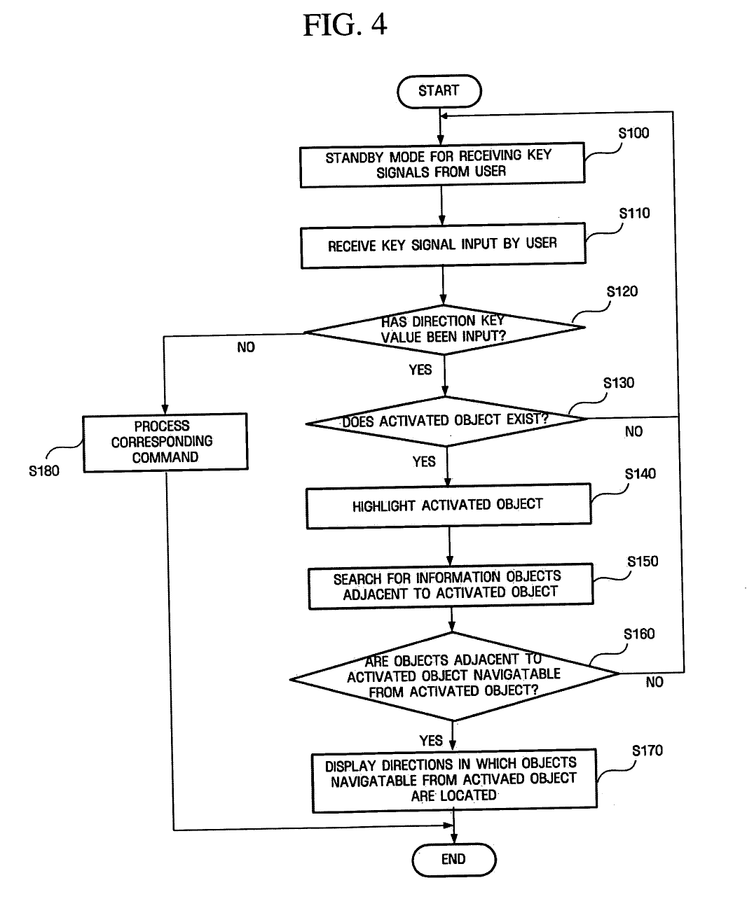

FIG. 4 is a flowchart of a display method for displaying directions, in which objects navigatable from a currently activated object are located, according to a preferred embodiment of the present invention. A digital TV will be taken as an example of the display apparatus according to the preferred embodiment of the present invention in the following paragraphs.

When a key signal is input to the receiving unit 100 by a user, the determiner 210 determines whether the input key signal indicates a request for changing channels or a request for performing a function regarding a predetermined object in steps S100 through S120.

If the input key signal is determined as a command signal indicating a request for changing channels, the determiner 210 transmits the input command signal to the channel changing unit 300 and the channel changing unit 300 changes channels in response thereto in step S180.

If the input key signal is determined as a command signal indicating a request for performing a function regarding a predetermined object, i.e., a direction key value, the determiner 210 transmits the input command signal to the searcher 220 and the searcher 220 detects whether there is an object currently activated on the screen of the digital TV in response thereto in step S130.

Then, if there is an object currently activated on the screen of the digital TV, the determiner 220 requests the event processor 230 and the event processor 230 processes the currently activated object to be highlighted in step S140.

Next, the searcher 220 searches for information on objects adjacent to the currently activated object in step S150. Here, the determiner 210 searches for the objects adjacent to the currently activated object and obtains information on relative locations of the searched objects by referring to a mapping table stored in the memory unit 500.

Thereafter, in step S160, it is determined whether the objects adjacent to the currently activated object are navigatable from the currently activated object, based on the location information of the objects adjacent to the currently activated object. If it is determined that the objects adjacent to the currently activated object are navigatable from the currently activated object, the searcher 220 sets display locations of the direction indicators indicating directions in which the objects navigatable from the currently activated object are located. Here, the locations of the direction indicators are set based on the location information of objects adjacent to the currently activated object. For example, the direction indicators are set to objects adjacent to the currently activated object or the currently activated object itself.

The display unit 600 displays the event created by the event processor 230 on the screen of the digital TV in step S170. That is, the currently activated object is highlighted on the screen of the digital TV, and the direction indicators are displayed on predetermined portions of the screen of the digital TV.

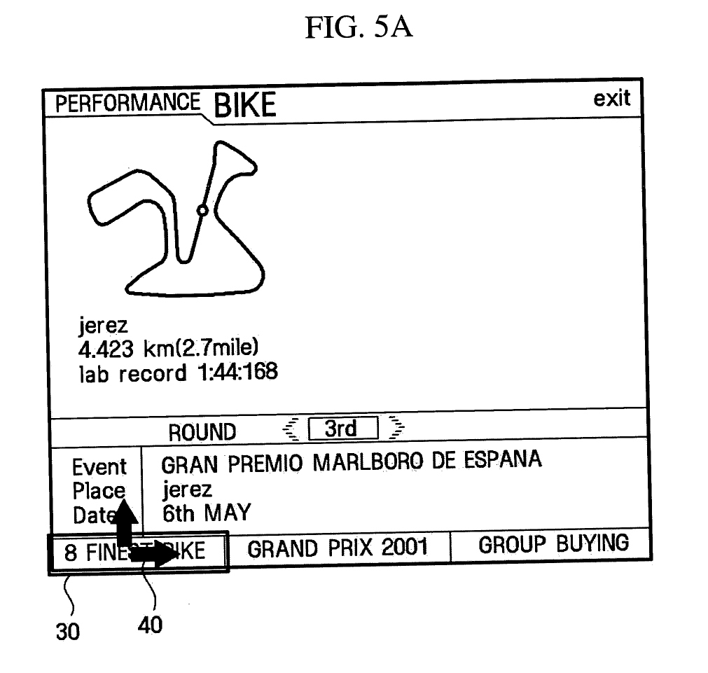

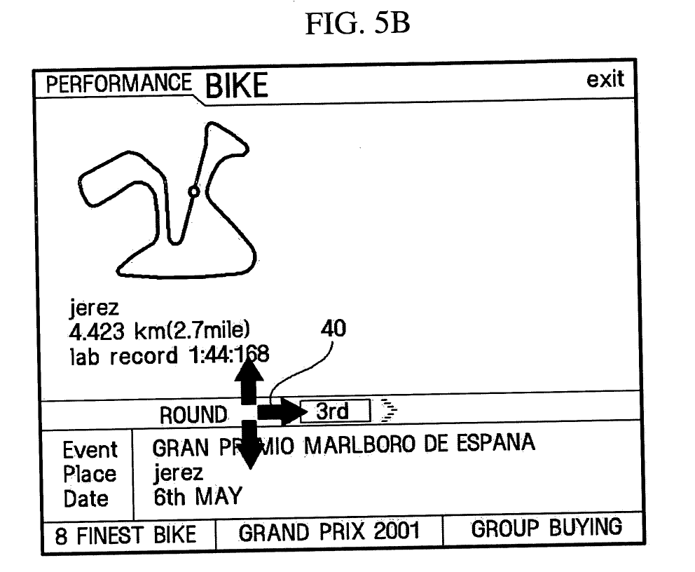

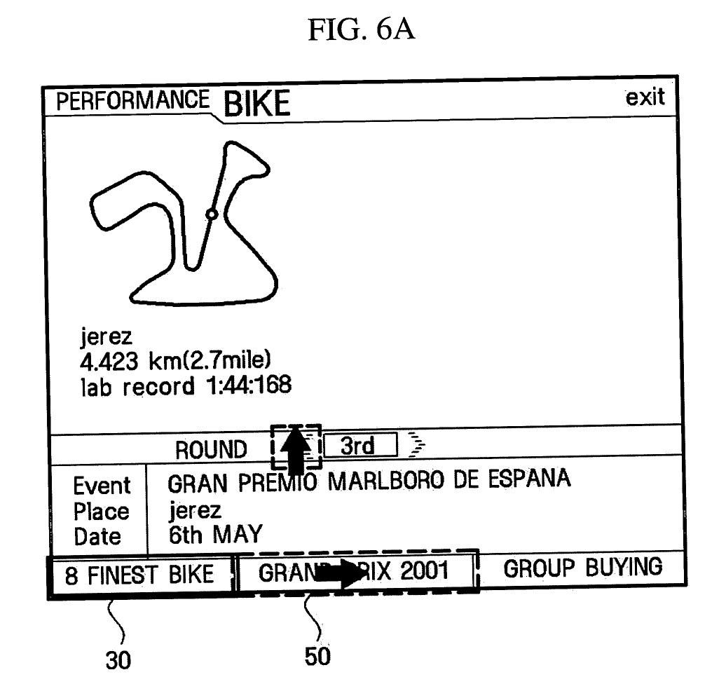

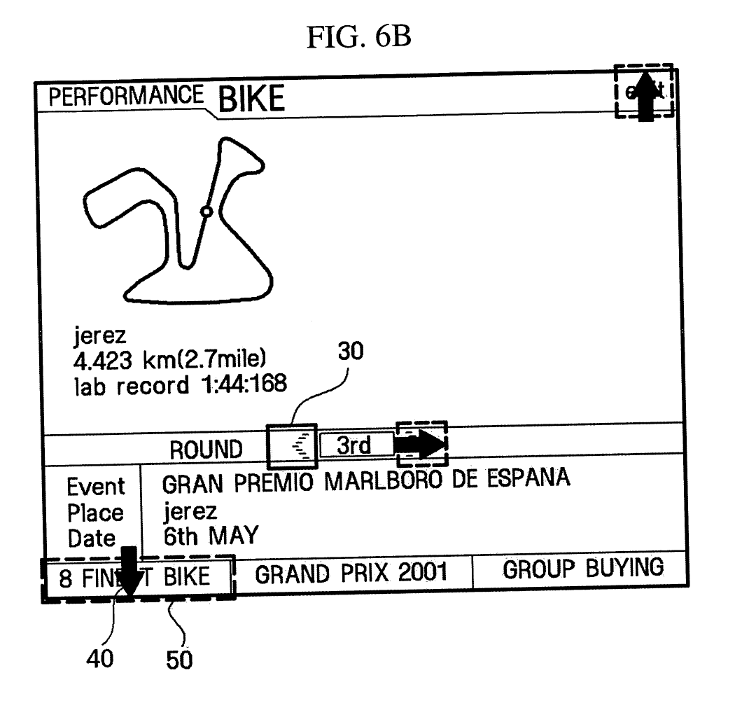

FIGS. 5A, 5B, 6A, and 6B are diagrams illustrating directions in which objects navigatable from a currently activated object are located on a screen of the display apparatus according to preferred embodiments of the present invention.

Referring to FIG. 5A, the currently activated object 30 displayed on the screen of the display apparatus is highlighted, and the direction indicators 40 are displayed on the currently activated object 30.

If a user press an ‘up’ key, an activated object is changed, that is, an object above the currently activated object 30 is newly highlighted (activated), and the direction indicators 40 are displayed on the newly highlighted object, as shown in FIG. 5B.

Other direction indicators in which objects navigatable from a currently activated object are located on a screen of the display apparatus according to an alternative embodiment of the present invention are shown in FIGS. 6A and 6B.

Referring to FIGS. 6A and 6B, the currently activated object 30 displayed on the screen of the display apparatus is highlighted, objects 50, which are navigatable from the currently activated object 30, are respectively highlighted, and the direction indicators 40 are respectively displayed on the objects 50 navigatable from the currently activated object 30.

If a user presses the ‘up’ key, an object above the currently activated object 30 is newly highlighted, objects navigatable from the newly highlighted object are respectively highlighted, and the direction indicators 40 are respectively displayed on the objects navigatable from the newly highlighted object, as shown in FIG. 6B.

The display apparatus and method according to the preferred embodiments of the present invention will now be described more fully with reference to FIGS. 5A, 5B, 6A, and 6B.

When a key signal is input by a user, it is determined whether the input key signal is a command signal requesting the changing of channels or a command signal requesting the performance of a function regarding a predetermined object. Hereinafter, it will be assumed that the input key signal is a command signal requesting the performance of the function regarding the predetermined object.

When the command signal requesting the performance of the function regarding the predetermined object is received, it is detected whether there is an object currently activated on a screen of a digital TV, and the currently activated object is highlighted. Here, the currently activated object 30 can be highlighted, as shown in FIGS. 5A and 6A.

Directions in which objects navigatable from the currently activated object 30 are located are detected by searching for linkage information of the currently activated object 30.

As a detection result, if the currently activated object 30 is only movable up or to the right, the direction indicators 40 are displayed on the currently activated object 30, as shown in FIG. 5A, to respectively indicate upward and rightward directions.

Alternatively, as shown in FIG. 6A, objects 50 navigatable from the currently activated object 30, i.e., objects, which are respectively located in directions in which the currently activated object 30 is movable, can be respectively highlighted, or the direction indicators 40 can be respectively displayed on the objects 50 navigatable from the currently activated object 30.

If the user presses an ‘up’ key, the object located above the currently activated object 30 is newly activated and highlighted, as shown in FIGS. 5B and 6B. Thereafter, information on directions in which objects navigatable from the newly activated object are located is searched for.

Directions, in which the objects navigatable from the newly activated object 30 are located, are displayed by searching for linkage information of the newly activated object. If objects navigatable from the newly activated object are respectively located above, to the right of, and below the newly activated object, the direction indicators 40 are displayed on the newly activated object so as to indicate upward, rightward, downward directions, as shown in FIG. 5B. Alternatively, as shown in FIG. 6B, the objects navigatable from the newly activated object can be respectively highlighted, and the direction indicators 40 can be respectively displayed on the objects navigatable from the newly activated object.

Accordingly, the present invention enables the user to more easily recognize directions in which objects navigatable from a currently activated object are located, and to more efficiently manipulate keys in desired directions by automatically displaying directions in which the objects navigatable from the currently activated object are located.

The preferred embodiments of the present invention have been described above as being applicable to digital TVs. However, they can also be applied to digital display devices other than digital TVs.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, according to the present invention, directions in which the objects navigatable from the currently activated object are located are automatically displayed, so that the user can more easily recognize directions in which objects navigatable from a currently activated object are located, and can more efficiently move a cursor from the currently activated object to any of the objects navigatable therefrom through key manipulation.

In addition, since the present invention uses conventional application program interface (API) specifications by slightly modifying drawing algorithms, no overhead is required for developing a new API.

1. A display apparatus that displays at least one direction in which at least one object navigatable from a currently activated object is located, the display apparatus comprising:
a display unit, which displays an application program;
an application program executing unit, which executes the application program so that the application program is displayed on a screen of the display unit; and
a controlling unit, which determines whether there is said at least one object navigatable from a currently activated object on the screen of the display unit and displays direction information on said at least one direction in which the at least one object navigatable from the currently activated object is located.

2. The display apparatus of claim 1, wherein the controlling unit displays the direction information by highlighting the currently activated object.

3. The display apparatus of claim 1, wherein the controlling unit displays the direction information by highlighting the at least one object navigatable from the currently activated object.

4. A display method that displays directions in which at least one object navigatable from a currently activated object is located, the display method comprising:
displaying an application program; and
determining whether there is at least one object navigatable from a currently activated object on the screen of the display unit and displaying direction information on said at least one direction in which the at least one object navigatable from the currently activated object is located.

5. The display method of claim 4, wherein the determining comprises:
searching for at least one object adjacent to the currently activated object by referring to a mapping table of the currently activated object;
obtaining information on relative locations of the searched at least one adjacent object; and
determining whether the at least one object adjacent to the currently activated object is navigatable from the currently activated object, based on the information on at least one location of the at least one object adjacent to the currently activated object.

6. The display method of claim 5, further comprising setting at least one location of at least one direction indicator indicating direction information according to information on at least one relative location of the searched at least one adjacent object.

7. The display method of claim 4, wherein in the displaying step, the direction information is displayed by highlighting the at least one object navigatable from the currently activated object.

8. The display method of claim 4, wherein the direction information is displayed by one of: 1) representing at least one direction indicator on one of the currently activated object and the at least one object navigatable from the currently activated object, and 2) highlighting the at least one object navigatable from the currently activated object.
